(19) United States
(12) Patent Application Publication
(10) Pub. No.: US 2023/0396044 A1
(43) Pub. Date: Dec. 7, 2023

(54) WIRE STRIPPER

(71) Applicant: Jianjun Han, Yuyao City (CN)

(72) Inventor: Jianjun Han, Yuyao City (CN)

(21) Appl. No.: 18/450,722

(22) Filed: Aug. 16, 2023

(30) Foreign Application Priority Data
Jul. 5, 2023 (CN) 2023217573683

(51) Int. Cl. H02G 1/12

(52) U.S. Cl. CPC H02G 1/1229

(57) ABSTRACT

A wire stripper includes a right and left handle, the right and left handle are rotatably connected by a pin shaft, a jaw is provided on front surfaces of top portions of the right and left handle respectively, and a right and left movable plate are correspondingly provided on back surfaces of the top portions of the right and left handle respectively; and the wire stripper further comprises a damping assembly, the damping assembly comprises a damping seat and a torsion spring, the damping seat is connected to the right movable plate, the torsion spring is connected to the left movable plate, the torsion spring has two relatively opened torsion spring arms, the two torsion spring arms respectively abut against both sides of the damping seat, and the two torsion spring arms are opened and tightened by relative reciprocating sliding between the damping seat and the torsion spring arms.

### TECHNICAL FIELD

The present invention pertains to the technical field of electrical tools, and specifically pertains to a wire stripper.

### BACKGROUND

Wire strippers are one of the tools commonly used by wiremen, motor repairmen and instrumentation electricians to strip surface insulation layers of the wire heads. The wire strippers can separate the insulation skin from the cut wire.

At present, commercially available multi-functional wire strippers have left and right wire stripping knife head fixing seats which are metallurgically integrally formed from a zinc alloy which is embedded into wire stripping blades and powder so as to achieve the purpose of wire stripping. Such products are expensive to manufacture and cumbersome to operate, and the damping structure is generally composed of a contact, a return spring and a knob; and the return spring is compressed by rotating the knob, and wires of different sizes are stripped by means of different degrees of compression of the spring, so as to strip wires of different gauges. That is, the amount of damping is adjusted by rotating the knob, which results in complicated structure, inconvenient production and assembly and disassembly and high cost.

### SUMMARY

The purpose of the present invention is to provide a wire stripper designed to solve the above-mentioned technical deficiency.

The present invention provides a wire stripper comprising a right handle and a left handle, the right handle and the left handle are rotatably connected by a pin shaft, a jaw is provided on front surfaces of top portions of the right handle and the left handle respectively, and a right movable plate and a left movable plate are correspondingly provided on back surfaces of the top portions of the right handle and the left handle respectively; and the wire stripper further comprises a damping assembly, the damping assembly comprises a damping seat and a torsion spring, the damping seat is connected to the right movable plate, the torsion spring is connected to the left movable plate, the torsion spring has two relatively opened torsion spring arms, the two torsion spring arms respectively abut against both sides of the damping seat, and the two torsion spring arms are opened and tightened by relative reciprocating sliding between the damping seat and the torsion spring arms.

As a further optimization, the jaw comprises a left mounting plate and a right mounting plate, the left mounting plate and the right mounting plate are respectively rotatably connected to the top portions of the left movable plate and the right movable plate, and the jaw further comprises a pressing end and a wire stripping end which are arranged opposite to each other;

the pressing end comprises an upper pressing seat and a lower pressing seat, the upper pressing seat is formed by stamping and bending the left mounting plate, and the lower pressing seat is formed by stamping and bending the left movable plate; and

the wire stripping end comprises an upper knife seat and a lower knife seat, the upper knife seat is formed by stamping and bending the right mounting plate, and the lower knife seat is formed by stamping and bending the right movable plate.

Preferably, a second mounting seat is provided between the upper pressing seat and the left mounting plate, a first mounting seat is provided between the upper knife seat and the right mounting plate, the two mounting seats have a respective coupling point and are rotatably connected to the corresponding mounting plate through the respective coupling point, and the upper pressing seat and the upper knife seat are respectively connected to the corresponding movable plate and rotate with the movable plate.

Preferably, the first mounting seat and the second mounting seat are made of plastic.

Preferably, the pressing end and the wire stripping end are made of sheet steel.

As a further optimization, the damping seat comprises a seat body with two open ends and guide side plates, the damping seat is connected to the right movable plate and moves with the right movable plate, the two torsion spring arms simultaneously enter from one open end and exit from both sides of the other open end, and the two torsion spring arms respectively abut against the two sides of the other open end; and the guide side plates are formed by bending both sides of the seat body.

As a further optimization, a tension spring is further provided between the left handle and the right handle, the left handle and the right handle are both provided with a spring hanging column, and an end portion of the tension spring takes the shape of a hook and is hook jointed to the corresponding spring hanging column.

Preferably, the spring hanging columns on the right handle and the left handle are of an anti-tension angular columnar structure formed by stamping and tearing.

Compared with the prior art, the present invention has the following technical effects: 1. it uses the structural characteristics that the damping assembly comprises the torsion spring and the damping seat, and the left handle and the right handle are tightened by means of the two torsion spring arms to achieve the damping sense of opening and closing the two handles, which result in simpler structure, more convenient assembly and disassembly and more advantageous cost; and 2, the pressing end, the wire stripping end and the mounting plates for wire stripping are all made of carbon steel, which is more stable in structure and lower in cost than the prior art alloy plates.

### BRIEF DESCRIPTION OF THE DRAWINGS

FIG. 1 is a front view of an overall structure of the present invention;

FIG. 2 is a back view of a top structure of a handle of the present invention;

FIG. 3 is a back view of a top structure of a handle of the present invention with the damping seat removed; and

FIG. 4 is a diagram of an assembly structure of a damping seat and a torsion spring of the present invention.

In the figures: 1. right handle; 2. left handle; 3. right movable plate; 4. left movable plate; 5. damping seat; 51. seat body; 52. guide side plate; 6. torsion spring arm; 7. right mounting plate; 8. left mounting plate; 9. pressing end; 91. upper pressing seat; 92. lower pressing seat; 10. wire stripping end; 101. upper knife seat; 102. lower knife seat; 11. first mounting seat; 12. second mounting seat; 13. movable column; 14. E-type circlip; 15. tension spring; 16. spring hanging column.

### DESCRIPTION OF THE EMBODIMENTS

A wire stripper, comprising a left handle and a right handle and a jaw, the two handles are rotatably connected around a pin shaft, the pin shaft is located at middle positions of the two handles, and a jaw is respectively connected to top portions of the two handles. The wire stripper further comprises a left movable plate 4 connected to the top portions of the left handle 2 and a right movable plate 3 connected to the top portions of the right handle 1, the left movable plate 4 and the right movable plate 3 closely adhered to the side of the top portion of the handles and are rotatably connected to the handles by the pin shafts, and the left movable plate 4 and the right movable plate 3 are symmetrically arranged.

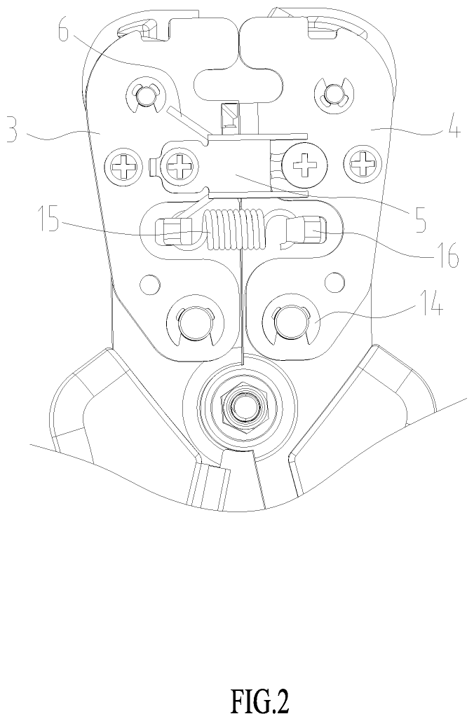

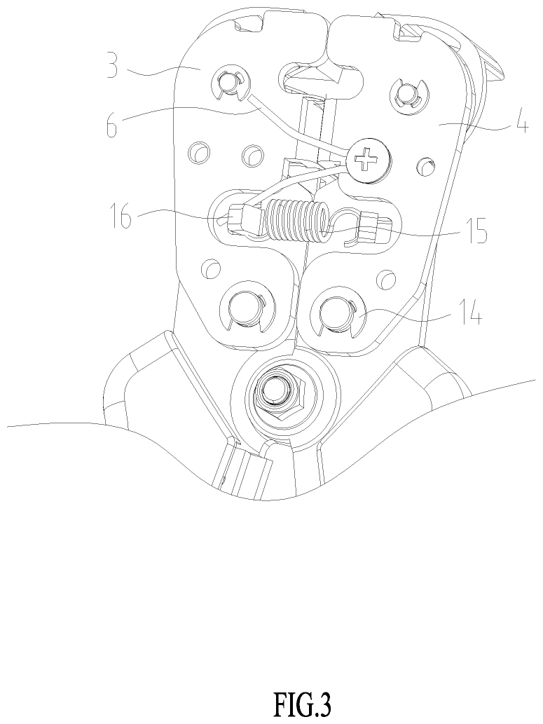

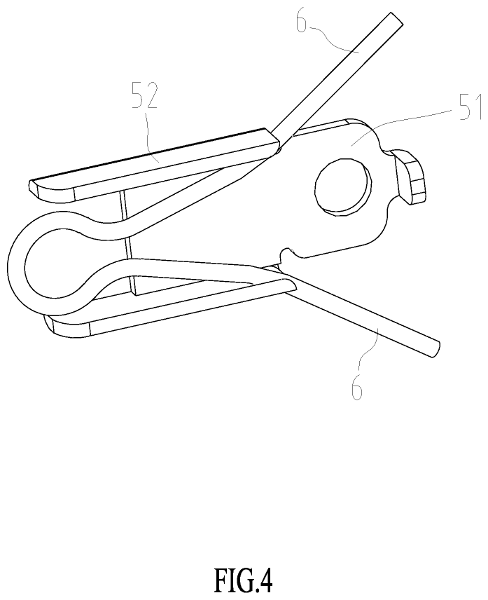

As shown in FIGS. 2-4, the wire stripper further comprises a damping assembly, the damping assembly comprises a damping seat 5 and a torsion spring, the damping seat 5 is connected to the right movable plate 3, the torsion spring is connected to the left movable plate 4, the torsion spring has two relatively opened torsion spring arms 6, the two torsion spring arms 6 respectively abut against both sides of the damping seat 5, and the two torsion spring arms 6 are opened and tightened by relative reciprocating sliding between the damping seat 5 and the torsion spring arms 6.

In the present embodiment, the damping seat 5 comprises a seat body 51 with two open ends, the two open ends are defined as an inlet and an outlet, the seat body 51 is in a plate-shaped structure; one end of the seat body 51 is connected to the right movable plate 3 by a fastener, so that the seat body 51 moves with the right movable plate 3; a torsion spring is mounted on the left movable plate 4 by a fastener; the inlet of the seat body 51 faces the torsion spring; two torsion spring arms 6 of the torsion spring are inserted simultaneously from the inlet and exit from the outlet; since the two torsion spring arms 6 are in an opened state, when the two torsion spring arms 6 exit from the outlet, the two torsion spring arms exit closely against both sides of the outlet, so that the two torsion spring arms 6 are respectively abutted against both sides of the outlet; when the right handle 1 and the left handle 2 rotate with each other, the right movable plate 3 and the left movable plate 4 are also opened and closed therewith; in an initial state, the left movable plate 4 and the right movable plate 3 are tightly fitted with each other, at this point, the damping seat 5 is located near a bottom end of the torsion spring arm 6, and the torsion spring is in a natural state; when the left movable plate 4 and the right movable plate 3 are separated from each other, the damping seat 5 and the torsion spring slide in a reverse direction to separate, at this point, the damping seat 5 slides along the torsion spring arm 6, and the damping seat 5 slides from the bottom end of the torsion spring arm 6 to an opened top end, so that the two torsion spring arms 6 are gradually tightened by the damping seat 5, thereby forming a damping motion; when the wire stripping action is completed, as the left movable plate 4 and the right movable plate 3 approach each other, the damping seat 5 and the torsion spring arm 6 also slide relative to each other, at this point, the damping seat 5 slides from the opened top end of the torsion spring to the bottom end, and the torsion spring returns from the tightened state to the opened state; and finally, a restoring force of the torsion spring drives the damping seat 5 to a bottom portion of the torsion spring arm 6, and the left movable plate 4 and the right movable plate 3 return to the initial state of tight fit.

In addition, both sides of the seat body 51 are bent towards the direction where the torsion spring arm 6 is located to form guide side plates 52, and the guide side plates 52 can not only protect the torsion spring, but also guide the torsion spring arm 6 in the relative sliding between the seat body 51 and the torsion spring arm 6, so as to make the sliding more stable.

It should be noted that the torsion spring arms 6 can be formed into a multi-section structure, that is, each torsion spring arm 6 presents a multi-section structure according to different opening angles, so that when the damping seat 5 slides along the two torsion spring arms 6 and tightens the two torsion spring arms 6, different damping sense can be achieved.

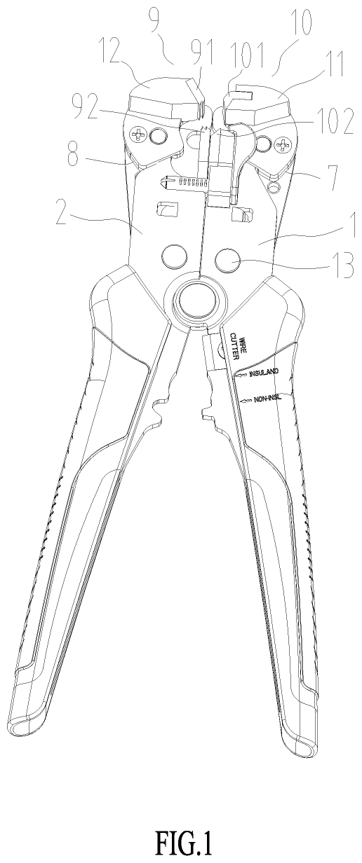

As shown in FIG. 1, the left mounting plate 8 and the right mounting plate 7 are respectively rotatably connected to the top portions of the right movable plate 3 and the left movable plate 4, and the jaw further comprises a pressing end 9 and a wire stripping end 10 which are arranged opposite to each other, the pressing end 9 comprises an upper pressing seat 91 and a lower pressing seat 92, and the upper pressing seat 91 is formed by stamping and bending the left mounting plate 8; and the lower pressing seat 92 is formed by stamping and bending the left movable plate 4.

The wire stripping end 10 comprises an upper knife seat 101 and a lower knife seat 102, the upper knife seat 101 is formed by stamping and bending the right mounting plate 7, and the lower knife seat 102 is formed by stamping and bending the right movable plate 3.

The upper pressing seat 91 and the upper knife seat 101 are provided with groove at side edges of respective turning points; top ends of the left handle 2 and the right handle 1 both extend to produce protrusions adapted to the grooves, and the protrusions are inserted into the grooves to form a running fit; when the left handle 2 and the right handle 1 rotate relative to each other, the protrusion on the corresponding handle drives the upper pressing seat 91 and the upper knife seat 101 to rotate about respective pin shafts, the pin shafts of the upper pressing seat 91 and the upper knife seat 101 are respectively located on outer sides of the upper pressing seat 91 and the upper knife seat 101, therefore, the opposite ends of the upper pressing seat 91 and the upper knife seat 101 rotate towards each other; the upper pressing seat 91 and the lower pressing seat 92 each are provided with a wire pressing groove, and when the upper pressing seat 91 rotates, the wire pressing groove of the upper pressing seat 91 moves toward the wire pressing groove of the lower pressing seat 92, so that the wire pressing groove of the upper pressing seat 91 and the wire pressing groove of the lower pressing seat 92 are engaged with each other, thereby pressing the wire and positioning the wire.

The upper knife seat 101 moves toward the lower knife seat 102, and cutting edges are provided on opposite faces of the upper knife seat 101 and the lower knife seat 102 such that the cutting edge of the upper knife seat 101 and the cutting edge of the lower knife seat 102 are engaged with each other, thereby cutting off plastic or rubber sheaths of wires.

In addition, a first mounting seat 11 is provided between the upper knife seat 101 and the left mounting plate 8, a second mounting seat 12 is provided between the upper pressing seat 91 and the left mounting plate 8, the two mounting seats have a respective coupling point and are rotatably connected to the corresponding mounting plate through the respective coupling point, and the upper pressing seat 91 and the upper knife seat 101 are respectively connected to the corresponding movable plate and rotate with the movable plate.

The first mounting seat 11 and the second mounting seat 12 are made of plastic.

The pressing end 9 is formed by bending a stamping of the left mounting plate 8, and the wire stripping end 10 is formed by bending a stamping of the right mounting plate 7, and they are both stampings and made of sheet steel. The wire stripping end 10 is integrated with the right mounting plate 7, and the pressing end 9 is integrated with the left mounting plate 8.

Rotatable connections between the right handle 1 and the right mounting plate 7, between the left handle 2 and the left mounting plate 8, between the first mounting seat 11 and the right mounting plate 7 and between the second mounting seat 12 and the left mounting plate 8 are all achieved by a movable column 13, and an E-type circlip 14 is clamped between one end of the movable column 13 and the mounting plate.

A tension spring 15 is further provided between the left handle 2 and the right handle 1, the left handle 2 and the right handle 1 are both provided with a spring hanging column 16, an end portion of the tension spring 15 takes the shape of a hook and is hook jointed to the corresponding spring hanging column 16, and the spring hanging column 16 is a columnar structure formed by stamping and tearing of the handle, and an anti-tension angular is formed between the columnar structure and the handle.

What is claimed is:

1. A wire stripper, comprising a right handle and a left handle, the right handle and the left handle being rotatably connected by a pin shaft, a jaw being provided on front surfaces of top portions of the right handle and the left handle respectively, and a right movable plate and a left movable plate being correspondingly provided on back surfaces of the top portions of the right handle and the left handle respectively, wherein the wire stripper further comprises a damping assembly, the damping assembly comprises a damping seat and a torsion spring, the damping seat is connected to the right movable plate, the torsion spring is connected to the left movable plate, the torsion spring has two relatively opened torsion spring arms, the two torsion spring arms respectively abut against both sides of the damping seat, and the two torsion spring arms are opened and tightened by relative reciprocating sliding between the damping seat and the torsion spring arms.

2. The wire stripper according to claim 1, wherein the jaw comprises a right mounting plate and a left mounting plate, the right mounting plate and the left mounting plate are respectively rotatably connected to the top portions of the right movable plate and the left movable plate, and the jaw further comprises a pressing end and a wire stripping end which are arranged opposite to each other;
the pressing end comprises an upper pressing seat and a lower pressing seat, the upper pressing seat is formed by stamping and bending the left mounting plate, and the lower pressing seat is formed by stamping and bending the left movable plate; and
the wire stripping end comprises an upper knife seat and a lower knife seat, the upper knife seat is formed by stamping and bending the right mounting plate, and the lower knife seat is formed by stamping and bending the right movable plate.

3. The wire stripper according to claim 2, wherein a second mounting seat is provided between the upper pressing seat and the left mounting plate, a first mounting seat is provided between the upper knife seat and the right mounting plate, the two mounting seats have a respective coupling point and are rotatably connected to the corresponding mounting plate through the respective coupling point, and the upper pressing seat and the upper knife seat are respectively connected to the corresponding movable plate and rotate with the movable plate.

4. The wire stripper according to claim 3, wherein the first mounting seat and the second mounting seat are made of plastic.

5. The wire stripper according to claim 2, wherein the pressing end and the wire stripping end are made of sheet steel.

6. The wire stripper according to claim 1, wherein the damping seat comprises a seat body with two open ends and guide side plates, the damping seat is connected to the right movable plate and moves with the right movable plate, the two torsion spring arms simultaneously enter from one open end and exit from both sides of the other open end, and the two torsion spring arms respectively abut against the two sides of the other open end; and the guide side plates are formed by bending both sides of the seat body.

7. The wire stripper according to claim 1, wherein a tension spring is further provided between the left handle and the right handle, the left handle and the right handle are both provided with a spring hanging column, and an end portion of the tension spring takes the shape of a hook and is hook jointed to the corresponding spring hanging column.

8. The wire stripper according to claim 7, wherein the spring hanging columns on the right handle and the left handle are of an anti-tension angular columnar structure formed by stamping and tearing.
